(19) United States
(12) Patent Application Publication
(10) Pub. No.: US 2022/0417113 A1
(43) Pub. Date: Dec. 29, 2022

(54) END-TO-END NETWORK PERFORMANCE GUARANTEES IN A CLOUD NATIVE ARCHITECTURE IN SERVICE PROVIDER NETWORKS

(71) Applicant: VMware, Inc., Palo Alto, CA (US)

(72) Inventors: Anil Lohiya, Cupertino, CA (US); Meenakshi Sundaram Selvaraj, Pleasanton, CA (US)

(21) Appl. No.: 17/748,842

(22) Filed: May 19, 2022

Related U.S. Application Data
(60) Provisional application No. 63/216,517, filed on Jun. 29, 2021.

(51) Int. Cl. H04L 41/5006; H04L 67/10; H04L 45/745

(52) U.S. Cl. CPC H04L 41/5006; H04L 67/10; H04L 45/745

(57) ABSTRACT

A method for providing performance guarantees for using microservices in a cloud-native architecture is provided. A network service controller specifies a set of performance characteristics for a particular service that is accessible by a network. The network service controller identifies a particular path in the network for the particular service having a performance guarantee that meets the specified set of performance characteristics. The network service controller configures a host machine running virtualization software with forwarding information for the particular path. The forwarding information is used to tag the packet with a list of transit nodes associated with the particular path when a packet is to be forwarded for the particular service.

### BACKGROUND

Cloud native architecture is an approach for building applications as microservices in public, private, and hybrid clouds, in which applications are run on containerized and dynamically orchestrated platforms. Cloud native architecture exploits the advantages of the cloud computing model. Cloud native applications are built and designed as loosely coupled systems, optimized for cloud scale and performance.

Microservice architecture is a type of service-oriented architecture (SOA) that arranges an application as a collection of loosely coupled services. In a microservices architecture, the protocols typically have relatively small overhead. Services are small in size, messaging-enabled, and bound by contexts. Individual services may be autonomously developed and independently deployed in a decentralized fashion.

### SUMMARY

Some embodiments of the invention provide a method for providing performance guarantees for microservices in a cloud-native architecture. A network service controller specifies a set of performance characteristics for a particular service that is accessible by a network. The network service controller identifies a particular path in the network for the particular service having a performance guarantee that meets the specified set of performance characteristics. The network service controller configures a host machine running virtualization software with forwarding information for the particular path. The forwarding information is used to tag the packet with a list of transit nodes associated with the particular path when a packet is to be forwarded for the particular service.

In some embodiments, the particular service is one of several cloud-based microservices provided by the network. In some embodiments, the network service controller specifies the set of performance characteristics associated with the particular service by receiving information regarding an identity of the particular service and a specification of a performance guarantee by using application programming interface (API). The set of performance characteristics may include bandwidth, latency, or reliability (e.g., packet drop rate.)

In some embodiments, the particular path is identified by (i) obtaining an address of the particular service, (ii) mapping the addresses of the particular service to a tunnel endpoint of a host machine that physically deploys an instance of the particular service, and (iii) computing a path toward the tunnel endpoint that the instance of the particular service is hosted. In some embodiments, the network service controller maintains a database for mapping microservices with (i) IP addresses of the microservices and (ii) tunnel endpoint addresses of host machines on which the microservices are implemented.

In some embodiments, the particular path is identified based on the specified set of performance characteristics by selecting a pre-defined logical network having a specified performance guarantee that satisfies the set of performance characteristics for the particular service. The performance guarantee of the particular path for the particular service is determined based on a performance characteristic of the particular service over the particular path. In some embodiments, the performance characteristic of the particular service over the particular path is determined based on the particular service's interactions with one or more microservices in the network over the particular path.

In some embodiments, the list of transit nodes/links associated with the particular path is appended to the packet in a segment routing header. In some embodiments, the host machine uses the list of transit nodes/links to forward the packet by (i) identifying a service associated with the packet based on fields in the packet, (ii) performing a lookup against installed flow entries to determine if the packet requires an additional source routing header, (iii) tagging the packet with additional metadata that identifies the packet as requiring a segment routing header, and (iv) performing a lookup against a segment routing table based on the metadata to obtain a list of addresses to append to the packet.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings, and the Claims is needed. Moreover, the claimed subject matters are not to be limited by the illustrative details in the Summary, Detailed Description, and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purposes of explanation, several embodiments of the invention are set forth in the following figures.

FIG. 1 illustrates a network service controller that provides performance guarantees associated with cloud-based services.

FIG. 2 conceptually illustrates a process for identifying a path to a service with a performance guarantee when forwarding a packet.

FIG. 3 conceptually illustrates the network service controller communicating with network discovery components in order to determine path information for services and their corresponding performance guarantees.

FIG. 4 illustrates a block diagram of the network service controller that generates forwarding information for providing performance guarantees of services.

FIG. 5 conceptually illustrates a process for identifying a path to a service with a performance guarantee when forwarding a packet.

FIG. 6 illustrates a computing device that serves as a host machine that runs virtualization software.

FIG. 7 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

When service providers offer revenue generating services and applications in their networks, it is a challenge to ensure different levels of performance guarantees from the underlying network, as applications of emerging business models may require high bandwidth, low latency, high reliability, or a combination of these performance guarantees. Network operators therefore attempt to optimize the use of network resources to meet these network requirements. When applications are built and deployed using cloud native architecture, service meshes can provide application-level routing and load balancing at L4-L7 layers. However, as service providers move deployment of software functions in the cloud native model, traffic management provided by service mesh and Kubernetes (an open-source system for automating deployment, scaling and management of containerized applications) remains agnostic to the underlying physical network. Obtaining specific performance guarantees from the underlying physical network can be difficult for applications using microservices in a cloud native architecture, as each microservice may have a different performance requirement.

Some embodiments of the invention provide a method to secure required performance guarantees from the underlying physical network for deploying applications with different characteristics, specifically applications built using microservices in a cloud native architecture, particularly in a virtualization software managed network or network virtualization environment. The method maps network performance requirements of microservices to the underlying network, steers network traffic through specific paths in the underlay networks that guarantee network performance for microservices, and creates logical networks that offer specific network performance guarantees over which microservices can be deployed.

In some embodiments, a network virtualization manager software (e.g., VMware NSX®) running on a central control plane (CCP) node of the network is used to manage and realize network resources. In some embodiments, the network virtualization manager provides high level intent application programming interface (API) via policy to specify the network performance requirements for a service. The network virtualization manager also interfaces with the service discovery components to map L3 IP addresses of a service to actual tunnel endpoints (e.g., virtual overlay tunnel endpoint, or VTEP) of host machines running virtualization software (or hypervisors). In some embodiments, the network virtualization manager software interfaces with a network service controller to trigger the path computation towards a specific tunnel endpoint. The network virtualization manager also programs source routing information in distributed routers on the host machines running virtualization software (e.g., hypervisors, VMware ESXi™) or edge gateways of the network virtualization manager (e.g., VMware NSX® Edge™).

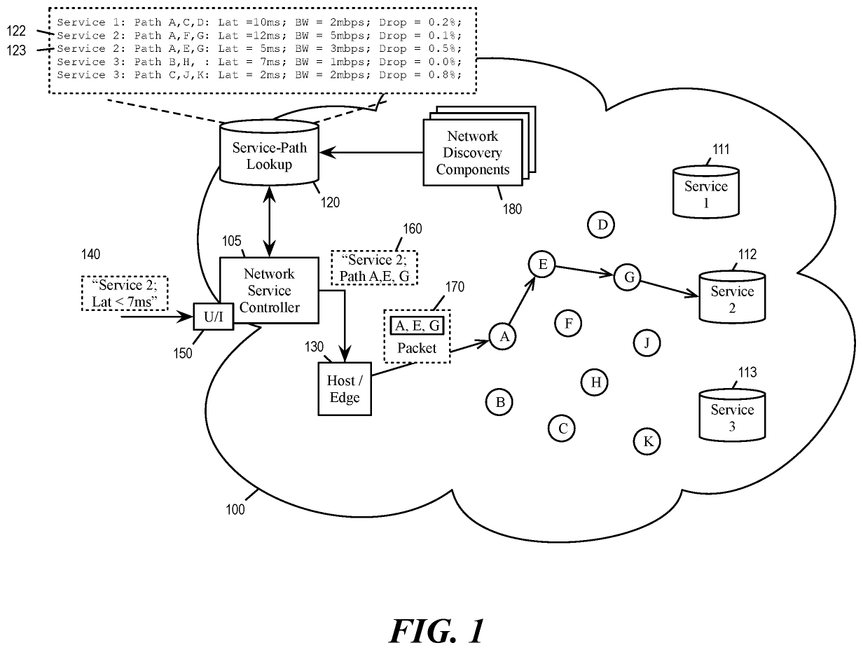

In some embodiments, the network service controller provides performance guarantees associated with network-based or cloud-based services by specifying a set of performance characteristics (or requirements or performance guarantees) for a particular service that is provided by a network. The network service controller identifies a particular path in the network for the particular service that meets or satisfies the specified set of performance characteristics. A host machine running virtualization software (or an edge gateway controlled by the network virtualization manager) is then configured (by the network service controller or by the network virtualization manager software) with forwarding information for the particular path such that when a packet is to be forwarded for the particular service, the forwarding information is used to tag the packet with a list of transit nodes/links in the network associated with the particular path. In some embodiments, the particular service is one of a plurality of cloud-based microservices provided by the network. FIG. 1 illustrates a network service controller that provides performance guarantees associated with cloud-based services.

As illustrated, a network 100 has a network service controller 105 that oversees the services provided by the network 100. The physical underlay of the network 100 provides paths to several services 111-113 (microservices 1, 2, and 3). These paths can be used by an edge or a host machine 130 running virtualization software (or hypervisor) to access those services 111-113, e.g., to send packets to those services. The network service controller 105 receives a specification 140 from a user interface 150. The user interface 150 is implemented by high-level intent APIs provided by the network virtualization manager (not illustrated). The specification 140 specifies a set of performance characteristics for the particular service. A set of performance characteristics specified by the user interface 150 may include any or a combination of bandwidth (e.g., in mbps), latency (e.g., in msec), reliability or packet drop rate, or any other measures of network performance.

The network service controller 105 then uses a service-path lookup 120 to look up a set of paths or forwarding information 160 for the set of performance characteristics. The forwarding information 160 specifies a particular path that can provide a performance guarantee when using the particular service. In other words, the set of performance characteristics is mapped to the particular path. The network service controller 105 (or the network virtualization manager software) then configures the edge or host machine 130 to use the forwarding information 160 when sending data traffic for the particular service.

In the example of FIG. 1, services 111, 112, and 113 correspond to microservices that are available to use by applications running in the network 100. The user interface (e.g., application program interface or API) 150 of the network service controller 105 specifies “latency<7 ms” as a desired set of performance characteristics for service 112 (“service 2”). The service-path lookup 120 is a database that maps performance guarantees for microservices to paths in the network 100. In the example, network service controller 105 selects an entry 123 in the service-path lookup 120 that satisfies the desired set of performance characteristics for service 112. The entry 123 specifies that, for service 2, a path traverses through transport nodes “A”, “E”, and “G” and has a latency metric of 5 ms, which meets the desired performance characteristics of (latency<7 ms). The content of the entry 123 is then configured into the host or edge machine 130 as part of the forwarding information 160. The host or edge 130 tags a packet 170 with a list of transit nodes/links that includes the nodes “A”, “E”, and “G”, enabling the packet 170 to reach the service 112 under the performance guarantee of latency<7 ms. As another example, if the desired performance characteristics is bandwidth>4 mbps for “service 2”, the network service controller 105 would select the entry 122 instead, which indicates that the path through “A”, “F”, and “G” has bandwidth of 5 mbps.

In some embodiments, the physical underlay of the network 100 may include physical computing resources such as host machines running virtualization software (e.g., VMware ESX®) to provide computing, storage, and edge resources and functionalities, (e.g., the host or edge 130). In some embodiments, the network 100 is controlled by a network virtualization manager (e.g., VMware NSX®) running on computing devices including the network service controller 105. In some embodiments, the network 100 may include host machines and physical underlays located in multiple different datacenters. The network 100 may also have different portions that are in different autonomous domains of control, e.g., domains under control of different telecommunications providers. In other words, a path for accessing a microservice may cross multiple different domains in the network 100.

In some embodiments, service orchestration is implemented for the network 100. Service orchestration refers to the automating of deployment, scaling, and management of application containers that are implemented across clusters of hosts in a network. Kubernetes, also called K8s, is an open-source container-orchestration system. In some embodiments, microservices in cloud native architecture can be deployed at the point-of-delivery (PoD) level or a specific container running in a Kubernetes PoD.

In some embodiments, the service-path lookup table 120 is populated by network discovery components 180. The network discovery components 180 are network entities or applications that have visibility across the entire network 100. Examples of such network discovery components 180 include service orchestrators (e.g., Kubernetes) or routing controllers. A routing controller controls routing in the network 100 and has information on the current state of the network, as well as which node and what links can provide a specific performance guarantee. In some embodiments, a routing controller may be a multi-domain routing controller that controls routing across different domains of the network 100.

In some embodiments, the network discovery components 180 discover the microservices and their locations (e.g., IP addresses) in the network 100. The IP address of a discovered service is mapped to a tunnel endpoint of a host machine that physically deploys or hosts an instance of the discovered service. For each discovered service, the network service controller 105 or the network discovery components 180 may compute a path toward the tunnel endpoint (of the ESX host) that the instance of the service is hosted. The network service controller 105 or the network discovery components 180 may also determine the performance guarantee of a particular path for a particular service based on a performance characteristic of the particular service over the particular path. In some embodiments, the performance characteristic of the particular service over the particular path is at least partially determined based on the particular service's interactions with one or more other services in the network over the particular path. The different paths of various performance guarantees for different microservices are identified in such manner and stored in the service-path lookup table 120. In some embodiments, a network discovery component 180 (e.g., a multi-domain routing controller) computes a path that satisfies a network performance guarantee for a particular service upon request (on-demand) by the network service controller 105. In some embodiments, the network service controller 105 makes a request for a path of a certain performance guarantee to be computed whenever a microservice instance is instantiated in the network 100.

In some embodiments, instead of (or in addition to) looking up individual paths with different performance guarantees for different services, the network service controller 105 may select from multiple pre-defined logical networks (or logical network slices) that provide different performance guarantees over the underlay network. In some embodiments, each logical network is an overlay network implemented by virtualization software running in host machines of the underlay network. Each logical network may cover nodes, links, and forwarding elements that are shared by multiple services, and a certain performance guarantee can be specified for the logical network as a whole. In some embodiments, pre-defined logical networks are used for identifying paths with performance guarantees when many instances of microservice(s) are running and a group of microservices have the same network performance requirements.

As mentioned, the network service controller 105 programs the host or edge 130 with forwarding information so that the host or edge 130 may tag packets of a particular service with a list of transit nodes or links associated with the particular path for a specified performance guarantee. In some embodiments, the list of transit nodes/links is a list of SRv6 addresses or MPLS labels. Thus, the final encapsulated packet will have the original packet, the overlay header, as well as the segment routing header (either SRv6 or SR-MPLS) and will be forwarded towards the first hop router. The packet will then be forwarded by segment routing (or source routing) in the network based on the list of transit nodes/links tagged to the packet. In some embodiments, all the transit nodes/traffic forwarders in the underlay network are assumed to support the segment routing.

In some embodiments, the segment routing header of a packet for using a particular service specifies forwarding path information that is determined by looking up flow entries related to the particular service. In order to append a segment routing header in the packet egressing from a host machine (running virtualization software), a lookup of flow entries installed at the host machine is used to determine if the packet requires appending additional source routing headers. The packet is tagged with additional metadata that identifies the packet as requiring a segment routing header and is used during the output processing. In the output processing, based on the metadata, additional lookup is done in the segment forwarding table. The result of the lookup provides the forwarding path information, e.g., a list of SRv6 addresses or MPLS labels that gets appended to the packet.

When the network service controller 105 configures the host or edge 130 with forwarding information, the forwarding information may include flow entries that specify IP addresses of a particular service and any other service that interacts with the particular service. The forwarding information may also include any L4-L7 information, next-hop information, as well as a segment list in the forwarding path. The segment list can be either a list of MPLS labels if SR-MPLS is enabled in the underlay network, or IPv6 addresses of the nodes if SRv6 is enabled in the underlay network. In some embodiments, the flow entries are installed at the host machine at a virtual interface of the virtualization software running in the host machine.

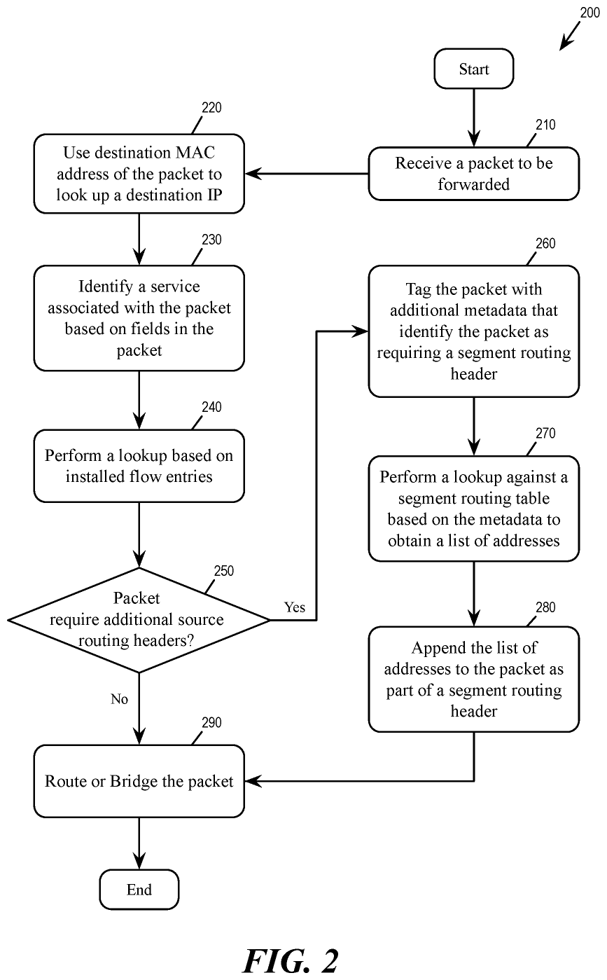

FIG. 2 conceptually illustrates a process 200 for identifying a path to a service with a performance guarantee when forwarding a packet. In some embodiments, the process 200 is performed by a host machine running network virtualization software, specifically at an I/O chain or packet forwarding pipeline. In some embodiments, one or more processing units (e.g., processor) of a computing device implementing the host machine perform the process 200 by executing instructions stored in a computer-readable medium.

The process 200 starts when the host machine receives (at 210) a packet to be forwarded. The process 200 uses (at 220) the destination MAC address of the packet to look up a destination IP address. The process 200 identifies (at 230) a service associated with the packet based on fields of the packet. In some embodiments, the service is also identified based on L3-L7 information, and other information that can be gathered by an interface of the virtualization software (e.g., vmnic).

The process 200 performs (at 240) a lookup of flow entries installed on the host machine for the identified service. In some embodiments, the flow entries specify IP addresses of different services and any other service that interacts with the particular service. Based on the result of the lookup, the process 200 determines (at 250) whether the packet requires an additional source routing header. In some embodiments, the virtualization software running on the host machine implements a segment routing (SR) module to perform the look up and determine whether the packet requires appending additional source routing headers. If the packet does not require an additional source routing header, e.g., because the identified service has a performance guarantee, the process 200 proceeds to 290 to route or bridge the packet. If the packet requires an additional source routing header, the process 200 proceeds to 260.

The process 200 tags (at 260) the packet with additional metadata that identify the packet as requiring additional source routing headers. The process 200 performs (at 270) a look up against a segment routing table based on the metadata to obtain a list of addresses (SRv6 addresses or MPLS labels) to append to the packet. The process 200 appends (at 280) the list of addresses to the packet as part of the segment routing header. The process 200 then proceeds to 290.

At 290, the process 200 forwards the packet to the next hop by performing routing or bridging. For a packet having a segment routing header, the packet will be segment routed according to the list of addresses in the header. The packet may also be encapsulated according to an overlay logical network. The process 200 then ends.

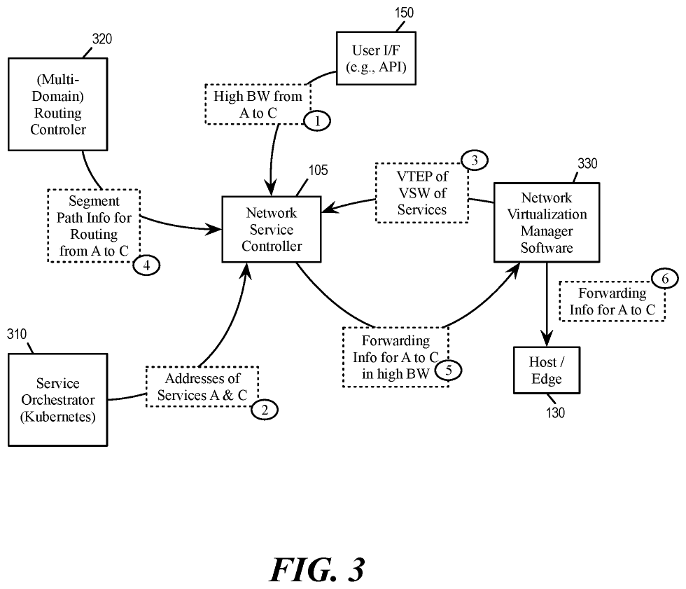

As mentioned, in some embodiments, the network service controller interfaces with several network discovery components (e.g., multi-domain network controllers and service orchestration) as well as the network virtualization manager to obtain information regarding paths for services and their corresponding performance guarantees. FIG. 3 conceptually illustrates the network service controller 105 communicating with network discovery components in order to determine path information for services and their corresponding performance guarantees.

As illustrated, the network service controller 105 has interfaces to communicate with the network virtualization manager software 330, the service orchestrator 310, and the routing controller 320. The network virtualization manager software 330 has interfaces for sending data to the host or edge 130. In some embodiments, the network service controller 105 is a software module that runs on a computing device that runs the service orchestrator 310 or the network virtualization manager software 330. In some embodiments, the network service controller 105 is a VM running on a host machine running a virtualization software (e.g., hypervisor) that is controlled by the network virtualization manager software 330.

The figure illustrates an example sequence of operations by which the network service controller 105 provides performance guarantees for a specific microservice. The operations are labeled (1) through (6). At the operation labeled (1), the network service controller 105 receives a request to provide a high-bandwidth link between microservice A and microservice C. In some embodiments, the request for a specific set of network characteristics is specified by using a high-level intent API.

At the operation labeled (2), the network service controller 105 interfaces with the service orchestrator 310 to obtain information about microservices A and C and their network location or addresses. In some embodiments, when a new PoD is deployed in the network, the network service controller 105 will get a notification about the microservice from a master node of the service orchestrator 310. This notification may include the name or label of the microservice, the IP address of the microservice (or rather the IP address of the pod), the node (virtual machine) IP address, and layer 4 port information (if any).

At the operation labeled (3), the network service controller 105 receives from the network virtualization manager software 330, a list of host machines or virtualization software (hypervisors) addresses (e.g., tunnel endpoint addresses) of microservices A and C. In some embodiments, the network service controller 105 performs a look up to map an IP address of a microservice to a tunnel endpoint of a host machine running virtualization software that is hosting an instance of a microservice. In some embodiments, the network service controller 105 maintains a database for mapping microservices with (i) IP addresses of the microservices and (ii) tunnel endpoint addresses of host machines on which the microservices are implemented.

At the operation labeled (4), the network service controller 105 receives from the routing controller 320, segment path information for routing from microservice A to microservice C. The information also identifies the path that is capable of providing high bandwidth from microservice A to microservice C. In some embodiments, the network service controller 105 requests the routing controller 320 to compute a path that can provide the desired network performance guarantee for the microservice. The routing controller 320 may be a multi-domain routing controller that can identify current states of different network domains, as well as nodes and links capable of a specific performance guarantee in different domains. In some embodiments, the network service controller 105 interfaces the routing controller 320 to trigger path computation toward the tunnel endpoint of a host machine running virtualization software at which the instance of the microservice is hosted.

At the operations labeled (5) and (6), the network service controller 105 provides forwarding information to the network virtualization manager software 330 to be programmed into host machines or edges 130. The forwarding information is for providing a link between microservices A and C that meets the high-bandwidth performance requirement. The forwarding information may specify a list of nodes or links for segment routing.

In some embodiments, the performance characteristics (or guarantee) of a microservice may be determined based on its interactions with other microservices. In some embodiments, the routing controller 320 or the network service controller 105 use a service graph of the microservice and its interactions with other microservices to determine the performance characteristics. The network service controller 105 may also determine which other microservice(s) this new instance of microservice can communicate with. In some embodiments, this information is obtained from a pre-created microservice graph provided by the user 150.

In some embodiments, the (multi-domain) routing controller 320 performs path computation between the two microservice endpoints and passes it the desired network performance constraints. In some embodiments, the network performance constraints are unidirectional from the new instance of the microservice to the other microservice(s), e.g., if there is a new instance of a content caching microservice that receives requests from other microservices (e.g. ‘retrieval service’), then it would send a video stream as a result of the request. In this case, a high-throughput guarantee would be required from the ‘content caching’ microservice to the other microservices (e.g., the ‘retrieval service’).

In some embodiments, a plugin-based architecture is used to ensure network performance guarantees for microservice(s), and the network service controller 105 is implemented as a network service intelligence (NSI) plugin module that resides in a Kubernetes master node as a container, or as a separate virtual machine in a host machine with virtualization software. Such a NSI plugin supports the dynamic determination of specific network paths between the services and/or creation of logical network slices. The NSI plugin interfaces with the microservice orchestrators 310 (such as Kubernetes), the multi-domain routing controller 320, and the network virtualization manager 330. The NSI plugin maps the network performance characteristics desired by a microservice to the actual underlay path(s) in the network, and programs the path information directly into edge gateways or host machines running virtualization software (e.g., host or edge 130). When packets are to be forwarded over specific paths, the list of transit nodes that a packet must traverse through is tagged along with the packet using standards-based protocol headers.

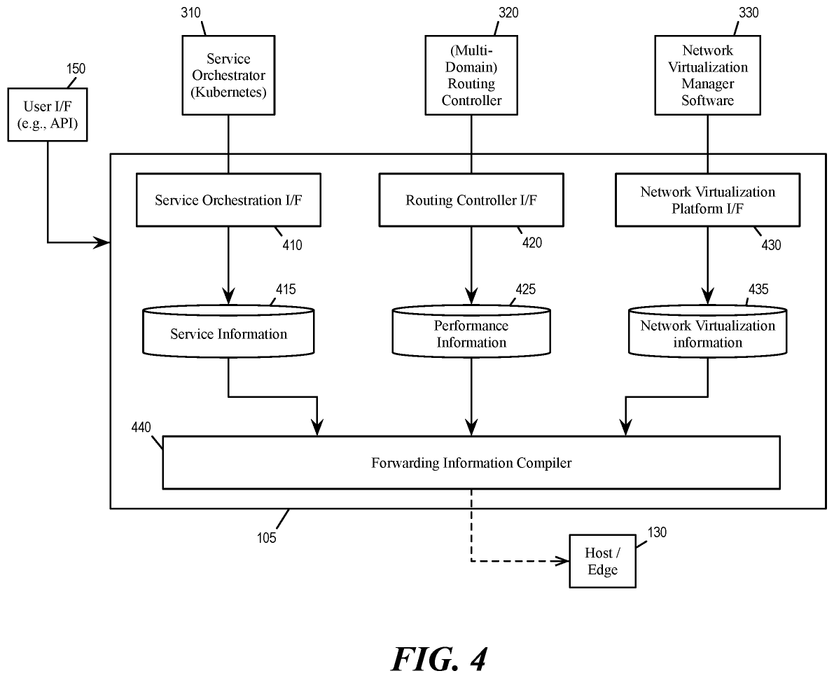

For some embodiments, FIG. 4 illustrates a block diagram of the network service controller 105 that generates forwarding information for providing performance guarantees of services. The network service controller 105 may be implemented by a bare metal computing device or a host machine running virtualization software. In some embodiments, the network service controller 105 is implemented as a plugin module that resides in a Kubernetes master node as a container, or as a separate virtual machine.

As illustrated, the network service controller 105 implements a service orchestration interface 410, a service information storage 415, a routing controller interface 420, a performance information storage 425, a network virtualization manager interface 430, a network virtualization information storage 435, and a forwarding information compiler 440. In some embodiments, the modules 410-440 are modules of software instructions being executed by one or more processing units (e.g., a processor) of a computing device. In some embodiments, the modules 410-440 are modules of hardware circuits implemented by one or more integrated circuits (ICs) of an electronic apparatus. Though the modules 410-440 are illustrated as being separate modules, some of the modules can be combined into a single module.

The service orchestration interface 410 is a module that communicates with the service orchestrator 310 to receive information on microservices, such as the IP addresses associated with the microservices. The obtained information on microservices is stored in the service information storage 415. In some embodiments in which the service orchestrator is implemented in a master node of Kubernetes, the service orchestration interface 410 may obtain the service information from the internal memories of the master node. In some embodiments in which the network service controller is implemented separately from the service orchestrator 310, the service orchestration interface 410 communicates with the service orchestration 310 through the network 100.

The routing controller interface 420 is a module that communicates with the (multi-domain) routing controller 320. The routing controller 320 has detailed information on the current state of the network in different domains and can provide performance measures or characteristics of paths in the network. In some embodiments, the routing controller interface 420 requests the routing controller 320 to compute a path for a particular service with a specified performance guarantee on an on-demand basis. In some embodiments, the routing controller 320 has pre-created logical network slices having specific performance guarantees, and the routing controller interface 420 may select a pre-created logical network for one or more services. The obtained performance information on paths and microservices is stored in the service information storage 415.

The network virtualization manager interface 430 is a module that communicates with the network virtualization manager software 330 (e.g., VMware NSX-T Datacenter™) running in a network controller. The network virtualization manager software 330 has information regarding host machines that implement the microservices, such as their tunnel endpoint addresses. The information obtained from the network virtualization manager software 330 is stored in the network virtualization information storage 435.

The forwarding information compiler 440 uses the information stored in the service information storage 415, the performance information storage 425, and the network virtualization information storage 435 to generate forwarding information to be used by host machines and edges, including the host or edge 130. In some embodiments, the forwarding information is delivered to the host machines and edges by the network virtualization manager 330.

In some embodiments, the interfaces 410, 420, and 430 communicate with their respective target entities based on inputs from the user interface 150. The inputs from the user interface 150 may be to request access to a particular service with a specific level of performance guarantee. The interfaces 410, 420, and 430 in turn communicate with the service orchestrator 310, the routing controller 320, and the network virtualization manager software 330 to obtain or generate information for the particular service, and to compute or identify a particular path capable of delivering the particular service at the specific performance guarantee. The forwarding information generated by the forwarding information compiler 440 therefore includes a list of transit nodes or links for segment routing packets to use the particular path.

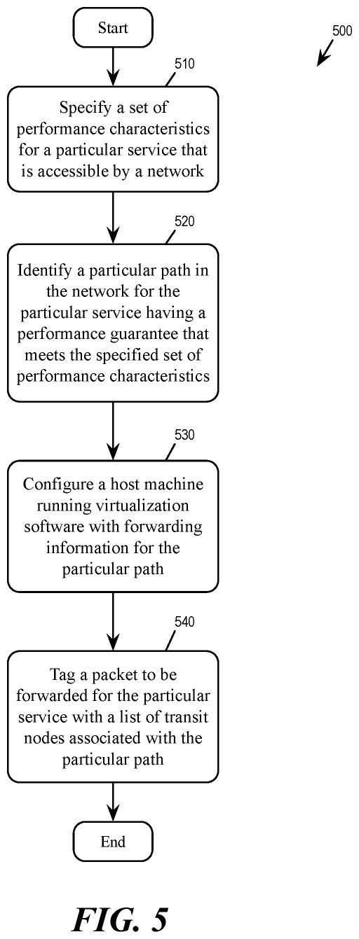

FIG. 5 conceptually illustrates a process 500 for identifying a path to a service with a performance guarantee when forwarding a packet. In some embodiments, the process 500 is performed by a host machine running network virtualization software that implements the network service controller 105. In some embodiments, the process 500 is performed by a machine hosting a master node of a service orchestrator 310 (e.g., Kubernetes.) In some embodiments, one or more processing units (e.g., processor) of a computing device implementing the host machine 130 perform the process 500 by executing instructions stored in a computer-readable medium.

The process 500 starts by specifying (at 510) a set of performance characteristics for a particular service that is accessible by a network. The particular service is one of several cloud-based microservices provided by the network. In some embodiments, the network service controller specifies the set of performance characteristics associated with the particular service by receiving information regarding an identity of the particular service and a specification of a performance guarantee by using an application programming interface (API). The set of performance characteristics may include bandwidth, latency, or reliability (e.g., packet drop rate.)

At 520, the process 500 identifies a particular path in the network for the particular service having a performance guarantee that meets the specified set of performance characteristics. In some embodiments, the particular path is identified by (i) obtaining an address of the particular service, (ii) mapping the addresses of the particular service to a tunnel endpoint of a host machine that physically deploys an instance of the particular service, and (iii) computing a path toward the tunnel endpoint that the instance of the particular service is hosted. In some embodiments, the network service controller maintains a database for mapping microservices with (i) IP addresses of the microservices and (ii) tunnel endpoint addresses of host machines on which the microservices are implemented.

In some embodiments, the particular path is identified based on the specified set of performance characteristics by selecting a pre-defined logical network having a specified performance guarantee that satisfies the set of performance characteristics for the particular service. The performance guarantee of the particular path for the particular service is determined based on a performance characteristic of the particular service over the particular path. In some embodiments, the performance characteristic of the particular service over the particular path is determined based on the particular service's interactions with one or more microservices in the network over the particular path.

At 530, the process 500 configures a host machine running virtualization software with forwarding information for the particular path.

At 540, the process 500 uses the forwarding information to tag the packet with a list of transit nodes associated with the particular path when a packet is to be forwarded for the particular service. The list of transit nodes/links associated with the particular path is appended to the packet in a segment routing header. The process 500 then ends. In some embodiments, the host machine uses the list of transit nodes/links to forward the packet by performing the process 200 of FIG. 2.

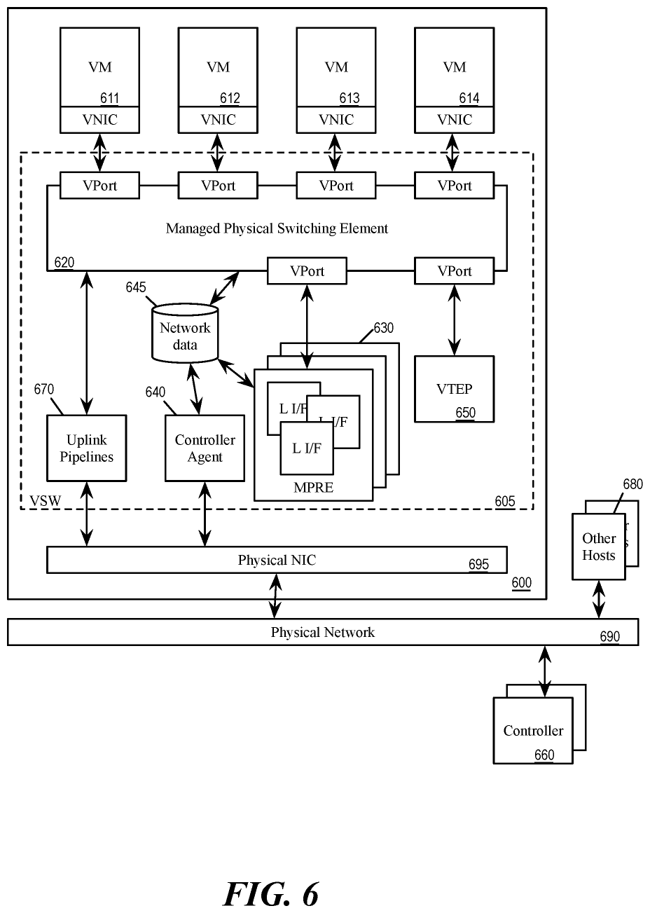

In some embodiments, the network service controller may be implemented by a host machine that is running virtualization software. Furthermore, the host or edge machine that is configured with the forwarding information is also a host machine running virtualization software. The virtualization software may serve as a virtual network forwarding engine. Such a virtual network forwarding engine is also known as a managed forwarding element (MFE), or hypervisor. Virtualization software allows a computing device to host a set of virtual machines (VMs) or data compute nodes (DCNs) as well as to perform packet-forwarding operations (including L2 switching and L3 routing operations). These computing devices are therefore also referred to as host machines. The packet forwarding operations of the virtualization software are managed and controlled by a set of central controllers, and therefore the virtualization software is also referred to as a managed software forwarding element (MSFE) in some embodiments. In some embodiments, the MSFE performs its packet forwarding operations for one or more logical forwarding elements as the virtualization software of the host machine operates local instantiations of the logical forwarding elements as physical forwarding elements. Some of these physical forwarding elements are managed physical routing elements (MPREs) for performing L3 routing operations for a logical routing element (LRE), some of these physical forwarding elements are managed physical switching elements (MPSEs) for performing L2 switching operations for a logical switching element (LSE). FIG. 6 illustrates a computing device 600 that serves as a host machine that runs virtualization software 605 for some embodiments of the invention.

As illustrated, the computing device 600 has access to a physical network 690 through a physical NIC (PNIC) 695. The host machine 600 also runs the virtualization software 605 and hosts VMs 611-614. The virtualization software 605 serves as the interface between the hosted VMs 611-614 and the physical NIC 695 (as well as other physical resources, such as processors and memory). Each of the VMs 611-614 includes a virtual NIC (VNIC) for accessing the network through the virtualization software 605. Each VNIC in a VM 611-614 is responsible for exchanging packets between the VM 611-614 and the virtualization software 605. In some embodiments, the VNICs are software abstractions of physical NICs implemented by virtual NIC emulators.

The virtualization software 605 manages the operations of the VMs 611-614, and includes several components for managing the access of the VMs 611-614 to the physical network 690 (by implementing the logical networks to which the VMs connect, in some embodiments). As illustrated, the virtualization software 605 includes several components, including a MPSE 620, a set of MPREs 630, a controller agent 640, a network data storage 645, a VTEP 650, and a set of uplink pipelines 670.

The VTEP (virtual tunnel endpoint) 650 allows the host machine 600 to serve as a tunnel endpoint for logical network traffic (e.g., VXLAN traffic). VXLAN is an overlay network encapsulation protocol. An overlay network created by VXLAN encapsulation is sometimes referred to as a VXLAN network, or simply VXLAN. When a VM 611-614 on the host machine 600 sends a data packet (e.g., an Ethernet frame) to another VM in the same VXLAN network but on a different host (e.g., other machines 680,) the VTEP 650 will encapsulate the data packet using the VXLAN network's VNI and network addresses of the VTEP 650, before sending the packet to the physical network 690. The packet is tunneled through the physical network 690 (i.e., the encapsulation renders the underlying packet transparent to the intervening network elements) to the destination host. The VTEP at the destination host decapsulates the packet and forwards only the original inner data packet to the destination VM. In some embodiments, the VTEP module 650 serves only as a controller interface for VXLAN encapsulation, while the encapsulation and decapsulation of VXLAN packets is accomplished at the uplink module 670.

The controller agent 640 receives control plane messages from a controller 660 (e.g., a CCP node) or a cluster of controllers. In some embodiments, these control plane messages include configuration data for configuring the various components of the virtualization software 605 (such as the MPSE 620 and the MPREs 630) and/or the virtual machines 611-614. In the example illustrated in FIG. 6, the controller agent 640 receives control plane messages from the controller cluster 660 from the physical network 690 and in turn provides the received configuration data to the MPREs 630 through a control channel without going through the MPSE 620. However, in some embodiments, the controller agent 640 receives control plane messages from a direct data conduit (not illustrated) independent of the physical network 690. In some other embodiments, the controller agent 640 receives control plane messages from the MPSE 620 and forwards configuration data to the MPRE 630 through the MPSE #-0620.

In some embodiments, the controller agent 640 receives the forwarding information from the control plane that may have originated from the network service controller 105 or a central control plane (CCP) node running the network virtualization manager software 330. The host machine 600 may receive packets for a particular microservice and use the received forwarding information to append a segment routing header that includes a list of transit links or nodes for a particular path.

The network data storage 645 in some embodiments stores some of the data that is used and produced by the logical forwarding elements of the host machine 600 (logical forwarding elements such as the MPSE 620 and the MPRE 630). Such stored data in some embodiments includes forwarding tables and routing tables, connection mappings, as well as packet traffic statistics. The stored data is accessible by the controller agent 640 in some embodiments and delivered to another computing device, e.g., a CCP node.

The MPSE 620 delivers network data to and from the physical NIC 695, which interfaces the physical network 690. The MPSE 620 also includes a number of virtual ports (vPorts) that communicatively interconnect the physical NIC 695 with the VMs 611-614, the MPREs 630, and the controller agent 640. Each virtual port is associated with a unique L2 MAC address, in some embodiments. The MPSE 620 performs L2 link layer packet forwarding between any two network elements that are connected to its virtual ports. The MPSE 620 also performs L2 link layer packet forwarding between any network element connected to any one of its virtual ports and a reachable L2 network element on the physical network 690 (e.g., another VM running on another host). In some embodiments, a MPSE is a local instantiation of a logical switching element (LSE) that operates across different host machines and can perform L2 packet switching between VMs on a same host machine or on different host machines. In some embodiments, the MPSE performs the switching function of several LSEs according to the configuration of those logical switches.

The MPREs 630 perform L3 routing on data packets received from a virtual port on the MPSE 620. In some embodiments, this routing operation entails resolving a L3 IP address to a next-hop L2 MAC address and a next-hop VNI (i.e., the VNI of the next-hop's L2 segment). Each routed data packet is then sent back to the MPSE 620 to be forwarded to its destination according to the resolved L2 MAC address. This destination can be another VM connected to a virtual port on the MPSE 620, or a reachable L2 network element on the physical network 690 (e.g., another VM running on another host, a physical non-virtualized machine, etc.).

As mentioned, in some embodiments, a MPRE is a local instantiation of a logical routing element (LRE) that operates across different host machines and can perform L3 packet forwarding between VMs on a same host machine or on different host machines. In some embodiments, a host machine may have multiple MPREs connected to a single MPSE, where each MPRE in the host machine implements a different LRE. MPREs and MPSEs are referred to as “physical” routing/switching elements in order to distinguish from “logical” routing/switching elements, even though MPREs and MPSEs are implemented in software in some embodiments. In some embodiments, a MPRE is referred to as a “software router” and a MPSE is referred to as a “software switch”. In some embodiments, LREs and LSEs are collectively referred to as logical forwarding elements (LFEs), while MPREs and MPSEs are collectively referred to as managed physical forwarding elements (MPFEs). Some of the logical resources (LRs) mentioned throughout this document are LREs or LSEs that have corresponding local MPREs or a local MPSE running in each host machine.

In some embodiments, the MPRE 630 includes one or more logical interfaces (LIFs) that each serve as an interface to a particular segment (L2 segment or VXLAN) of the network. In some embodiments, each LIF is addressable by its own IP address and serves as a default gateway or ARP proxy for network nodes (e.g., VMs) of its particular segment of the network. In some embodiments, all of the MPREs in the different host machines are addressable by a same “virtual” MAC address (or vMAC), while each MPRE is also assigned a “physical” MAC address (or pMAC) in order to indicate in which host machine the MPRE operates.

The uplink module 670 relays data between the MPSE 620 and the physical NIC 695. The uplink module 670 includes an egress chain and an ingress chain that each perform a number of operations. Some of these operations are pre-processing and/or post-processing operations for the MPRE 630.

As illustrated by FIG. 6, the virtualization software 605 has multiple MPREs 630 for multiple, different LREs. In a multi-tenancy environment, a host machine can operate virtual machines from multiple different users or tenants (i.e., connected to different logical networks). In some embodiments, each user or tenant has a corresponding MPRE instantiation of its LRE in the host for handling its L3 routing. In some embodiments, though the different MPREs belong to different tenants, they all share a same vPort on the MPSE, and hence a same L2 MAC address (vMAC or pMAC). In some other embodiments, each different MPRE belonging to a different tenant has its own port to the MPSE.

The MPSE 620 and the MPRE 630 make it possible for data packets to be forwarded amongst VMs 611-614 without being sent through the external physical network 690 (so long as the VMs connect to the same logical network, as different tenants' VMs will be isolated from each other). Specifically, the MPSE 620 performs the functions of the local logical switches by using the VNIs of the various L2 segments (i.e., their corresponding L2 logical switches) of the various logical networks. Likewise, the MPREs 630 perform the function of the logical routers by using the VNIs of those various L2 segments. Since each L2 segment/L2 switch has its own unique VNI, the host machine 600 (and its virtualization software 605) is able to direct packets of different logical networks to their correct destinations and effectively segregate traffic of different logical networks from each other.

Many of the above-described features and applications are implemented as software processes that are specified as a set of instructions recorded on a computer-readable storage medium (also referred to as computer-readable medium). When these instructions are executed by one or more processing unit(s) (e.g., one or more processors, cores of processors, or other processing units), they cause the processing unit(s) to perform the actions indicated in the instructions. Examples of computer-readable media include, but are not limited to, CD-ROMs, flash drives, RAM chips, hard drives, EPROMs, etc. The computer-readable media does not include carrier waves and electronic signals passing wirelessly or over wired connections.

In this specification, the term “software” is meant to include firmware residing in read-only memory or applications stored in a magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

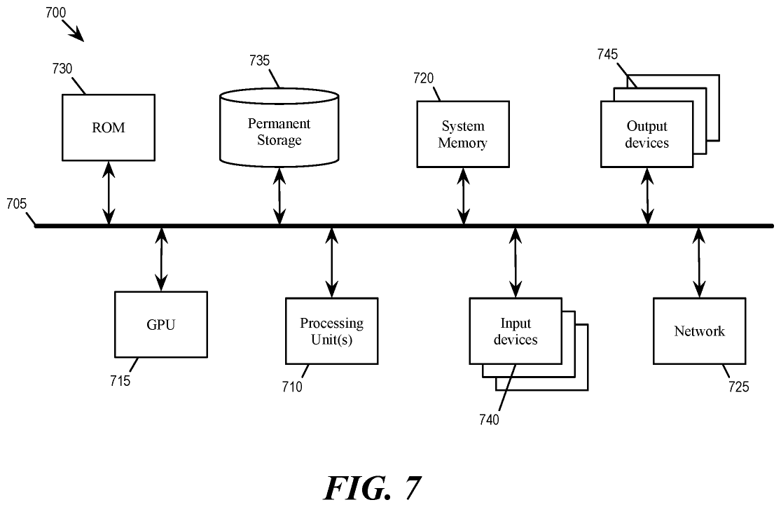

FIG. 7 conceptually illustrates a computer system 700 with which some embodiments of the invention are implemented. The computer system 700 can be used to implement any of the above-described hosts, controllers, and managers. As such, it can be used to execute any of the above-described processes. This computer system 700 includes various types of non-transitory machine-readable media and interfaces for various other types of machine-readable media. Computer system 700 includes a bus 705, processing unit(s) 710, a system memory 720, a read-only memory 730, a permanent storage device 735, input devices 740, and output devices 745.

The bus 705 collectively represents all system, peripheral, and chipset buses that communicatively connect the numerous internal devices of the computer system 700. For instance, the bus 705 communicatively connects the processing unit(s) 710 with the read-only memory 730, the system memory 720, and the permanent storage device 735.

From these various memory units, the processing unit(s) 710 retrieve instructions to execute and data to process in order to execute the processes of the invention. The processing unit(s) 710 may be a single processor or a multi-core processor in different embodiments. The read-only-memory (ROM) 730 stores static data and instructions that are needed by the processing unit(s) 710 and other modules of the computer system 700. The permanent storage device 735, on the other hand, is a read-and-write memory device. This device 735 is a non-volatile memory unit that stores instructions and data even when the computer system 700 is off. Some embodiments of the invention use a mass-storage device (such as a magnetic or optical disk and its corresponding disk drive) as the permanent storage device 735.

Other embodiments use a removable storage device (such as a floppy disk, flash drive, etc.) as the permanent storage device 735. Like the permanent storage device 735, the system memory 720 is a read-and-write memory device. However, unlike storage device 735, the system memory 720 is a volatile read-and-write memory, such as a random-access memory. The system memory 720 stores some of the instructions and data that the processor needs at runtime. In some embodiments, the invention's processes are stored in the system memory 720, the permanent storage device 735, and/or the read-only memory 730. From these various memory units, the processing unit(s) 710 retrieve instructions to execute and data to process in order to execute the processes of some embodiments.

The bus 705 also connects to the input and output devices 740 and 745. The input devices 740 enable the user to communicate information and select commands to the computer system 700. The input devices 740 include alphanumeric keyboards and pointing devices (also called “cursor control devices”). The output devices 745 display images generated by the computer system 700. The output devices 745 include printers and display devices, such as cathode ray tubes (CRT) or liquid crystal displays (LCD). Some embodiments include devices such as a touchscreen that function as both input and output devices 740 and 745.

Finally, as shown in FIG. 7, bus 705 also couples computer system 700 to a network 765 through a network adapter (not shown). In this manner, the computer 700 can be a part of a network of computers (such as a local area network (“LAN”), a wide area network (“WAN”), or an Intranet, or a network of networks, such as the Internet. Any or all components of computer system 700 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to a microprocessor or multi-core processors that execute software, some embodiments are performed by one or more integrated circuits, such as application-specific integrated circuits (ASICs) or field-programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer-readable medium,” “computer-readable media,” and “machine-readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Several embodiments described above include various pieces of data in the overlay encapsulation headers. One of ordinary skill will realize that other embodiments might not use the encapsulation headers to relay all of this data.

Also, several figures conceptually illustrate processes of some embodiments of the invention. In other embodiments, the specific operations of these processes may not be performed in the exact order shown and described in these figures. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

We claim:

1. A method comprising:
specifying a set of performance characteristics for a particular service that is accessible by a network;
identifying a particular path in the network for the particular service having a performance guarantee that meets the specified set of performance characteristics; and
configuring a host machine running virtualization software with forwarding information for the particular path, wherein when a packet is to be forwarded for the particular service, the forwarding information is used to tag the packet with a list of transit nodes associated with the particular path.

2. The method of claim 1, wherein the particular service is one of a plurality of cloud-based microservices provided by the network.

3. The method of claim 1, wherein identifying the particular path comprises:
obtaining an address of the particular service;
mapping the addresses of the particular service to a tunnel endpoint of a host machine that physically deploys an instance of the particular service; and
computing a path toward the tunnel endpoint that the instance of the particular service is hosted.

4. The method of claim 1, wherein identifying the particular path based on the specified set of performance characteristics comprises selecting a pre-defined logical network having a specified performance guarantee that satisfies the set of performance characteristics for the particular service.

5. The method of claim 1, wherein the performance guarantee of the particular path for the particular service is determined based on a performance characteristic of the particular service over the particular path.

6. The method of claim 5, wherein the performance characteristic of the particular service over the particular path is determined based on the particular service's interactions with one or more microservices in the network over the particular path.

7. The method of claim 1, wherein the list of transit nodes associated with the particular path is appended to the packet in a segment routing header.

8. The method of claim 1, wherein forwarding the packet comprises:
(i) identifying a service associated with the packet based on fields in the packet;
(ii) performing a lookup against installed flow entries to determine if the packet requires an additional source routing header;
(iii) tagging the packet with additional metadata that identifies the packet as requiring a segment routing header; and
(iv) performing a lookup against a segment routing table based on the metadata to obtain a list of addresses to append to the packet.

9. The method of claim 1, wherein specifying the set of performance characteristics associated with the particular service comprises receiving information regarding an identity of the particular service and a specification of a performance guarantee by using an application programming interface (API).

10. The method of claim 1, wherein the set of performance characteristics comprises at least one of bandwidth, latency, and reliability.

11. The method of claim 1, further comprising maintaining a database for mapping microservices with (i) IP addresses of the microservices and (ii) tunnel endpoint addresses of host machines on which the microservices are implemented.

12. A computing device comprising:
one or more processors; and
a computer-readable storage medium storing a plurality of computer-executable components that are executable by the one or more processors to perform a plurality of actions, the plurality of actions comprising:
specifying a set of performance characteristics for a particular service that is accessible by a network;
identifying a particular path in the network for the particular service having a performance guarantee that meets the specified set of performance characteristics; and
configuring a host machine running virtualization software with forwarding information for the particular path, wherein when a packet is to be forwarded for the particular service, the forwarding information is used to tag the packet with a list of transit nodes associated with the particular path.

13. The computing device of claim 12, wherein identifying the particular path comprises:
obtaining an address of the particular service;
mapping the addresses of the particular service to a tunnel endpoint of a host machine that physically deploys an instance of the particular service; and
computing a path toward the tunnel endpoint that the instance of the particular service is hosted.

14. The computing device of claim 12, wherein identifying the particular path based on the specified set of performance characteristics comprises selecting a pre-defined logical network having a specified performance guarantee that satisfies the set of performance characteristics for the particular service.

15. The computing device of claim 12, wherein the performance guarantee of the particular path for the particular service is determined based on a performance characteristic of the particular service over the particular path, wherein the performance characteristic of the particular service over the particular path is determined based on the particular service's interactions with one or more microservices in the network over the particular path.

16. The computing device of claim 12, wherein the list of transit nodes associated with the particular path is appended to the packet in a segment routing header.

17. The computing device of claim 12, wherein forwarding the packet comprises:
(i) identifying a service associated with the packet based on fields in the packet;
(ii) performing a lookup against installed flow entries to determine if the packet requires an additional source routing header;
(iii) tagging the packet with additional metadata that identifies the packet as requiring a segment routing header; and
(iv) performing a lookup against a segment routing table based on the metadata to obtain a list of addresses to append to the packet.

18. The computing device of claim 12, wherein specifying the set of performance characteristics associated with the particular service comprises receiving information regarding an identity of the particular service and a specification of a performance guarantee by using an application programming interface (API).

19. The computing device of claim 12, wherein the set of performance characteristics comprises at least one of bandwidth, latency, and reliability.

20. The computing device of claim 12, wherein the plurality of actions further comprises maintaining a database for mapping microservices with (i) IP addresses of the microservices and (ii) tunnel endpoint addresses of host machines on which the microservices are implemented.
